(19) United States
(12) Patent Application Publication
(10) Pub. No.: US 2023/0162133 A1
(43) Pub. Date: May 25, 2023

(54) METHOD AND SYSTEM FOR SELECTING VENDOR ON A DIGITAL PLATFORM

(71) Applicant: FLIPKART INTERNET PRIVATE LIMITED, Bengaluru (IN)

(72) Inventors: Aditya Siva Sasi Prasanth Bandaru, Guntur (IN); Gowtham Bellala, Bangalore (IN); Abhinav Grover, New Delhi (IN); Govind Pandey, Bengaluru (IN)

(73) Assignee: FLIPKART INTERNET PRIVATE LIMITED, Bengaluru (IN)

(21) Appl. No.: 17/987,035

(22) Filed: Nov. 15, 2022

(30) Foreign Application Priority Data
Nov. 22, 2021 (IN) 202141053844

(51) Int. Cl. G06Q 10/0834; G06Q 10/0639

(52) U.S. Cl. CPC G06Q 10/0834; G06Q 10/0639

(57) ABSTRACT

The present disclosure relates to a method and system for selecting a vendor on a digital platform. Said method comprises: (1) retrieving, by a transceiver unit [104], a data comprising a set of delivery performance factors data and a net promoter score; (2) identifying, by a processing unit [102], an association between the set of delivery performance factors data and the net promoter score; (3) determining, by the processing unit [102], a dynamic weight for one or more delivery performance factors, based on the association between the set of delivery performance factors data and the net promoter score; (4) determining, by the processing unit [102], a vendor performance score based on the one or more delivery performance factors and the dynamic weights associated with the one or more delivery performance factors; and (5) selecting, by a selection unit [106], the vendor based on the vendor performance score.

### RELATED APPLICATION

This application claims priority under 35 U.S.C. § 119 to Indian Patent Application No. 202141053844, filed on Nov. 22, 2021, the entire contents of which are incorporated herein by reference

### FIELD OF THE DISCLOSURE

The present disclosure relates generally to the field of supply chain logistics for digital platforms. More particularly, the disclosure relates to methods and systems for scoring and selecting a third-party logistics vendor on a digital platform.

### BACKGROUND

The following description of related art is intended to provide background information pertaining to the field of the disclosure. This section may include certain aspects of the art that may be related to various features of the present disclosure. However, it should be appreciated that this section be used only to enhance the understanding of the reader with respect to the present disclosure, and not as admissions of prior art.

Companies, especially in the e-commerce domain have started outsourcing their logistic operations to third-party logistics service providers (3PL). Thus, third-party logistics (3PL) service providers are becoming increasingly popular around the world as logistics and supply chain management are two critical components of business performance for companies nowadays. Many e-commerce companies have their in-house supply chain network. However, the conventional model of handling many or all operations in-house has not proved to be very productive or cost effective. Thus, in order to provide better services to customers in the locations where their network is limited, they tie-up with third party logistics service providers. The developments and implementation of Information Technology allows for building stronger networks across geographic regions, making collaborations between 3PL service providers. Many consumers of 3PL services also believe that the collaborations with 3PL service providers or vendors have helped them in achieving their objectives of providing services to their customers at reasonable cost, thus increasing customer satisfaction. Thus, owing to their contributions in cost reduction, productivity gains, and an improvement in customer service quality, these 3PL vendors have become key players in handling supply chain logistics especially for e-commerce industry. Once the decision to work with a 3PL service provider has been taken, it is important to select among various 3PL service providers as to which 3PL to assign the task of handling the logistic operations. As a result, selecting an efficient and promising 3PL vendors that can fulfil a customer's needs and can strengthen ties with the customers becomes critical as it also affects overall sales and business.

Thus, time and again, solutions have been provided to improve the services provided to the customers in this regard. These solutions have been able to improve customer satisfaction to a limited extent. Thus, there exists an imperative need in the art to provide a system and method for scoring and selecting a third-party logistics vendor on a digital platform. This will help maximise the efficiency in selecting the third-party logistics vendors and thereby increase the customer's experience and satisfaction along with time and cost effectiveness.

### SUMMARY

This section is intended to introduce certain objects and aspects of the disclosed method and system in a simplified form and is not intended to identify the key advantages or features of the present disclosure.

One aspect of the present disclosure relates to a system for selecting vendor on a digital platform. Said system comprises a transceiver unit configured to retrieve a data comprising a set of delivery performance factors data and a net promoter score for each historical order of one or more vendors on the digital platform. Also, the system comprises a processing unit configured to identify an association between the set of delivery performance factors data and the net promoter score. Further, the processing unit determines a dynamic weight for one or more delivery performance factor of the set of delivery factors based on the association between the set of delivery performance factors data and the net promoter score. Further, the processing unit determines a vendor performance score based on the one or more delivery performance factors and the dynamic weights associated with the one or more delivery performance factors. Also, a selection unit is configured to select the vendor based on the vendor performance score.

Another aspect of the present disclosure relates to a method for selecting a vendor on a digital platform. Said method comprises: (1) retrieving, by a transceiver unit, a data comprising a set of delivery performance factors data and a net promoter score for each historical order of one or more vendors on the digital platform; (2) identifying, by a processing unit, an association between the set of delivery performance factors data and the net promoter score; (3) determining, by the processing unit, a dynamic weight for one or more delivery performance factor of the set of delivery factors based on the association between the set of delivery performance factors data and the net promoter score; (4) determining, by the processing unit, a vendor performance score based on the one or more delivery performance factors and the dynamic weights associated with the one or more delivery performance factors; and (5) selecting, by a selection unit, the vendor based on the vendor performance score.

### BRIEF DESCRIPTION OF DRAWINGS

The accompanying drawings, which are incorporated herein, and constitute a part of this disclosure, illustrate exemplary embodiments of the disclosed methods and systems in which like reference numerals refer to the same parts throughout the different drawings. Components in the drawings are not necessarily to scale, emphasis instead being placed upon clearly illustrating the principles of the present disclosure. Some drawings may indicate the components using block diagrams and may not represent the internal circuitry of each component. It will be appreciated by those skilled in the art that disclosure of such drawings includes disclosure of electrical components, electronic components or circuitry commonly used to implement such components.

FIG. 1 illustrates an architecture of a system for selecting vendor on a digital platform, in accordance with exemplary embodiments of the present disclosure.

FIG. 2 illustrates an exemplary method flow diagram depicting a method for selecting vendor on a digital platform, in accordance with exemplary embodiments of the present disclosure.

FIG. 3 illustrates an exemplary impact of order to delivery time and extent of breach on net promoter score, as part of an instance implementation of a method for selecting vendor on a digital platform, in accordance with exemplary embodiments of the present disclosure.

FIG. 4 illustrates a set of exemplary SHAP Values aggregated on a training data, as a part of an instance implementation of a method for testing of datacenter hardware across days, in accordance with exemplary embodiments of the present disclosure.

The foregoing shall be more apparent from the following more detailed description of the disclosure.

### DETAILED DESCRIPTION

In the following description, for the purposes of explanation, various specific details are set forth in order to provide a thorough understanding of embodiments of the present disclosure.

It will be apparent, however, that embodiments of the present disclosure may be practiced without these specific details. Several features described hereafter can each be used independently of one another or with any combination of other features. An individual feature may not address any of the problems discussed above or might address only some of the problems discussed above. Some of the problems discussed above might not be fully addressed by any of the features described herein. Example embodiments of the present disclosure are described below, as illustrated in various drawings in which like reference numerals refer to the same parts throughout the different drawings.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosure as set forth.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

As used herein, a “processor” or “processing unit” includes processing unit, wherein processor refers to any logic circuitry for processing instructions. A processor may be a general-purpose processor, a special purpose processor, a conventional processor, a digital signal processor, a plurality of microprocessors, one or more microprocessors in association with a DSP core, a controller, a microcontroller, Application Specific Integrated Circuits, Field Programmable Gate Array circuits, any other type of integrated circuits, etc. The processor may perform signal coding data processing, input/output processing, and/or any other functionality that enables the working of the system according to the present disclosure. More specifically, the processor or image processing unit is a hardware processor.

As discussed in the background section, it is important to carefully select among various third party logistics (3PL) vendors or service providers, as to which 3PL vendor to assign the task of handling the logistic operations. Also, selecting an efficient and promising 3PL vendor is critical as it also affects overall sales and business as well as the customer experience. Thus, every order must be allocated to one of the vendors based on some selection criteria and by following certain constraints in order to maximise effectiveness in selecting the best vendors to serve the purpose.

In a known solution, a system for obtaining manual ratings from the customers is used for ranking the vendors. A survey is sent to customers after the delivery of a product by a vendor. In the survey, the customers are asked to rate the delivery of their product and their feedback on how likely they are to recommend the digital platform to other people. The ratings and reviews are further analysed using pre-defined methods. After ranking the vendors, the orders are allocated to top ranked vendors while ensuring that the vendor capacity and serviceability constraints are satisfied.

However, the major drawbacks of this system are: (1) sparsity of feedback data available, and (2) delays experienced in the data availability. Further, there is noise in the data as well.

In another known solution, methods of identifying suppliers for a customer are disclosed. This is based on the logistics requirements such as mode of transport, cost, origin point and destination point, travel time, delivery date, environmental impact and operational performance, etc. This is a computer-based method for assisting the logistics decision of a customer. It receives a logistics requirement from a customer, calculates at least one suitable option from the list of supplier-provided logistics options, and outputs at least one logistics option. This calculation of the suitable option of supplier may be based on scoring of operational performance of the supplier. And such scoring may also be based on factors such as transit time, number of consignments delivered on time, breached, damaged, lost etc.

However, a major drawback of this system is that it uses some fixed weights to get the operational performance score. Thus, it may not be able to provide accurate results in selecting a supplier for the customer. There is no calculation of dynamic parameters that are based on changing demands and hence, do not provide a system that maximises effectiveness in selecting the best vendors for serving the logistic requirements of customers on a digital platform. Thus, a system is required which overcomes the drawbacks of above prior arts.

Hereinafter, exemplary embodiments of the present disclosure will be described in detail with reference to the accompanying drawings so that those skilled in the art can easily carry out the solution provided by the present disclosure.

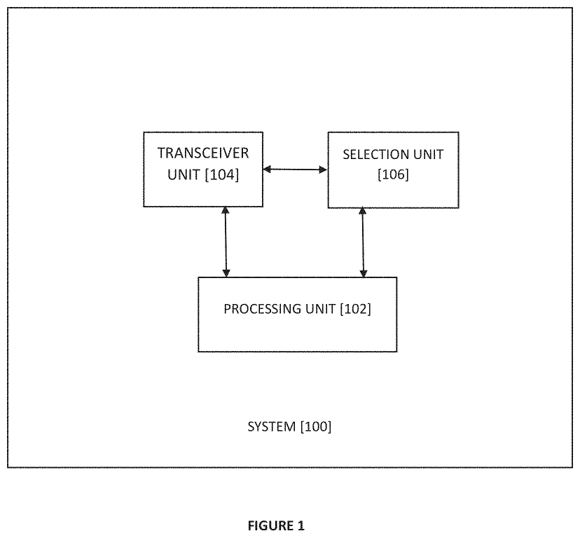

FIG. 1 illustrates an architecture of a system for selecting vendor on a digital platform, in accordance with exemplary embodiments of the present disclosure. As shown, the system [100] comprises a processing unit [102], a transceiver unit [104] and a selection unit [106], operably connected to each other unless otherwise specifically indicated.

The transceiver unit [104] is configured to retrieve a data comprising a set of delivery performance factors data and a net promoter score (NPS) for each historical order of one or more vendors. This data may be retrieved by the transceiver unit [104] from any one or more of the storage spaces or devices such as a memory disc integrated on the system [100], a memory storage device placed outside the body of system [100] externally connected with the system [100] through wired or wireless means, a memory storage device that forms a part of another system or computing device, a cloud storage space, or any other system that is used to store any kind of data. A person skilled in the art would appreciate that the memory storage space refers to any kind of device or storage unit that is known in the art or may be developed in the future. The data retrieved by the transceiver unit [104] includes a set of delivery performance factors data and a net promoter score (NPS) for each historical order of one or more vendors. These one or more vendors can be some or all of the vendors that are associated with the digital platform as third-party logistic (3PL) vendors or service providers.

Further, the set of delivery performance factors data of the one or more vendors includes one or more of the features such as an order to delivery time, an extent of breach, a first attempt conversion, a shipping category, a service profile, a computed cluster, a payment type, a city tier, and a value variable, repromise, escalation, last mile experience. A person skilled in the art would appreciate that these factors as mentioned here are only exemplary and used for the purpose of understanding. The present disclosure encompasses all other factors that might be thought of or developed in the future. The Order to Delivery Time (O2D) is defined as the number of days from order date to delivered date. The Extent of Breach is defined as the number of days the order has been breached by, i.e., Max (0, delivered date—promised date). Further, First Attempt Conversion (FAC) is A binary signal denoting if the shipment was delivered on the first attempt by the last mile agent or not. If the shipment is delivered on the first attempt by the last mile agent, then the FAC flag value is set to “1”, else “0”. The above factors may be categorised as delivery related factors. There are other factors that may be categorised as order related, or customer related. Shipping category denotes the shipping category for the product (e.g., Books, Mobiles, Electronics, etc.). The net promoter score may vary significantly with the shipping category. For example, mobiles may have a net promoter score of 80 compared to 65 for some other type of product such as books. Although the overall delivery experience may be better for mobiles compared to books. The difference in the net promoter score may not entirely and sufficiently signify the delivery experience. The net promoter score for mobiles may even be better with the same delivery experience as that of books. Service Profile determines whether the order is fulfilled by the digital platform itself or by a third party. Similarly, there is data related to the set of delivery performance factors data of the one or more vendors which includes other parameters as well, that is retrieved by the transceiver unit [104].

In an implementation, the transceiver unit [104] retrieves the data comprising a set of delivery performance factors data and a net promoter score for each historical order of one or more vendors on the digital platform, from a memory storage space (not shown) and sends it to the processing unit [102]. The processing unit [102] is configured to identify an association between the set of delivery performance factors data and the net promoter score. The data of each historical order could be, for example, the data of all the orders made in the past 14 days or any number of days as may be suitable. Thus, the processing unit [102] identifies the association based on this data and determines a dynamic weight for the delivery performance factors that have been processed from the set of all delivery factors. These dynamic weights are based on the identified association between the set of delivery performance factors data and the net promoter score.

In another implementation of the present disclosure, the processing unit [102] can use any modelling system to determine dynamic weights for the delivery performance factors, for example, SHAP (Shapley additive explanations) is one of the modelling systems that may be used. This modelling system used for identifying the association between the set of delivery performance factors data and the net promoter score may be regarded as a pre-trained scoring sub-system. The dynamic weight for each delivery performance factor is one of a positive weight or a negative weight. A ‘zero weight’, i.e., neither positive nor negative weight means that the delivery performance factor is not affecting the vendor performance score and thus, is not affecting the selection of the vendor on the digital platform. Further, the positive dynamic weight indicates a positive contribution in the vendor performance score and the negative dynamic weight indicates a negative contribution in the vendor performance score.

Further, the processing unit [102] determines a vendor performance score based on the processed delivery performance factors and the dynamic weights associated with the processed delivery performance factors. In an implementation, the vendor scoring function is a simple weighted linear model. The vendor performance score can be computed at a lane granularity that is defined by <source, destination, category>. For example, a vendor scoring function that is a simple weighted linear model, based on three delivery performance factors, i.e., order to delivery time, extent of breach, and first attempt conversion, can be represented as:

F_{S,D,C}^{Vendor}=w_{o2d}*x_{o2d}^{Vendor}+w_{breach}*w_{breach}^{Vendor}+w_{fac}*x_{fac}^{Vendor}

where, wᵢ's (w_{o2d}, w_{breach}, w_{fac}) are the are the mean absolute weights. These wᵢ's can be derived from SHAP using a training data. And, xᵢ^{Vendor}'s (x_{o2d}^{Vendor} x_{breach}^{Vendor} x_{fac}^{Vendor}) denote the normalized mean values of the delivery attributes (O2D, extent of breach, and FAC) over the orders delivered in the previous days, say for example, last 14 days. Thus, the vendor performance score comprises determining a normalized mean value of one or more delivery performance factors from the set of delivery performance factors for a predefined period of time.

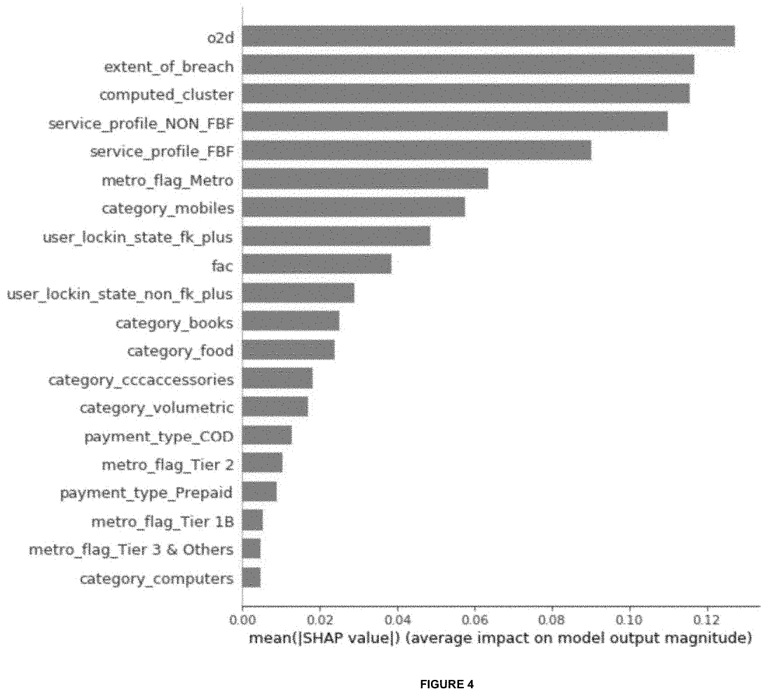

For example, referring to FIG. 4, it illustrates a set of exemplary SHAP Values aggregated on a training data. A person skilled in the art would appreciate that these are the exemplary values represent dynamic weights that are derived from the training data used for the training the pre-trained scoring sub-system or the modelling system. A person skilled in the art would also note that the exemplary SHAP values shown in the FIG. 4 are the modulus of the mean SHAP values aggregated for the entire training data fed to the pre-trained scoring sub-system. Accordingly, as noted in the figure, using the corresponding SHAP values of O2D, extent of breach, and FAC, the following exemplary vendor scoring function is obtained:

P^{Vendor}=0.038*x_{fac}^{Vendor}−0.128*x_{o2d}^{Vendor}−0.117*x_{breach}^{Vendor}

It is pertinent to note that positive weight for FAC as it is positively correlated with NPS, and negative weights for O2D and breach as they are negatively correlated with NPS. Further, a person skilled in the art would appreciate that these values of dynamic weights are only exemplary and used for the purpose of understanding. The values may change for another set of training data as fed to the pre-trained scoring sub-system.

Further, in an implementation, let y_{o2d}^{Vendor} denote the average O2D of the orders delivered by a vendor in the last 14 days. Let y_{o2d}^{max} and y_{o2d}^{min} denote the maximum and minimum values of y_{o2d}^{Vendor} across all vendors. In order to normalize all the attributes to a common scale (0-1), a min-max normalization approach can be applied and xᵢ^{Vendor} values can be obtained by using:

$${x}_{o 2 d}^{Vendor} = \frac{{y}_{o 2 d}^{Vendor} - {y}_{o 2 d}^{min}}{{y}_{o 2 d}^{max} - {y}_{o 2 d}^{min}}$$

In this, it is possible that the shipment's handover was delayed thereby causing a breach in the promised delivery time. In such case, the breach is not attributable to the vendor. So x_{breach}^{Vendor} is computed for only those shipments whose breach was caused by the vendor i.e., the handover to the vendor was completed as scheduled but a delay in delivery was caused by the vendor.

Further, the delivery performance factors considered along with the dynamic weights, i.e., w_{o2d}*x_{o2d}^{Vendor}, w_{breach}*x_{breach}^{Vendor}, and W_{fac}*x_{fac}^{Vendor}, are called feature importances, that are the additive values used for determining the vendor performance score.

Now, referring again to FIG. 1, the selection unit [106] is provided to select a vendor based on the vendor performance score that is determined by the processing unit [102], for all the vendors that are associated with the digital platform to provide logistic services for the digital platform. In this, various parameters such as vendor's capacity, budget constraints and serviceability constraints are also considered while calculating the overall score for optimally selecting or allocating the vendor. Here, vendor's capacity refers to the maximum load shipments that can be delivered by a vendor in a given time, budget constraints include the costs or charges of the vendor to deliver a shipment, and serviceability constraints include whether a vendor delivers shipments in a geographical region or not.

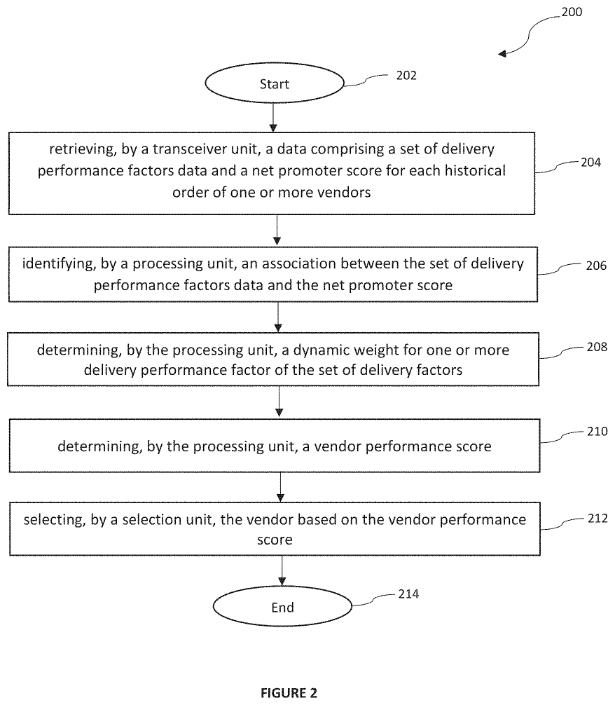

Referring to FIG. 2, an exemplary method flow diagram depicting a method for selecting vendor on a digital platform. The method starts at step 202 and goes to step 204. At step 204, the transceiver unit [104] retrieves a data comprising a set of delivery performance factors data and a net promoter score for each historical order of one or more vendors. This data may be retrieved by the transceiver unit [104] from any one or more of the storage spaces or devices such as a memory disc integrated on the system [100], a memory storage device placed outside the body of system [100] externally connected with the system [100] through wired or wireless means, a memory storage device that forms a part of another system or computing device, a cloud storage space, or any other system that is used to store any kind of data. A person skilled in the art would appreciate that the memory storage space refers to any kind of device or storage unit that is known in the art or may be developed in the future.

In this exemplary implementation, the transceiver unit [104] retrieves the data comprising a set of delivery performance factors data and a net promoter score for each historical order of one or more vendors on the digital platform, from a memory storage space (not shown) and sends it to the processing unit [102]. At step 206, processing unit [102] identifies an association between the set of delivery performance factors data and the net promoter score. The data of each historical order could be, for example, the data of all the orders made in the past 14 days or any number of days as may be suitable.

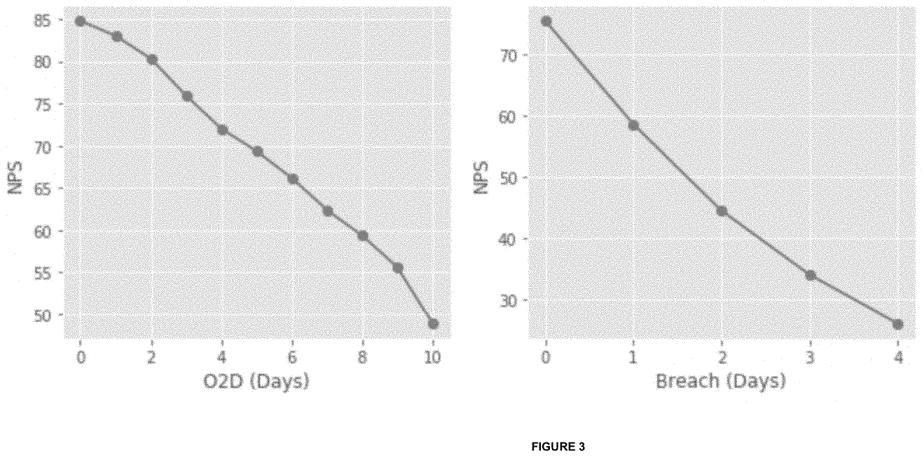

For example, referring to FIG. 3, it illustrates an exemplary impact of order to delivery time and extent of breach on net promoter score. One skilled in the art may observe that as the time taken from order to delivery increases, the net promoter score (NPS) decreases for a vendor. In the exemplary graph as shown in FIG. 3, for 0 days taken from order to delivery, meaning that the product is delivered the same day as the order is placed, the net promoter score is 85. And, this net promoter score gradually decreases as the number of days increase, and goes down to 50 for 10 days of time taken by the vendor to deliver a product from the day when the order was placed on the digital platform. Similarly, a person skilled in the art may also observe the decrease in the net promoter score (NPS) with the increase in the breach of days, that is, more number of days are extended beyond the promised date of delivery of the product, lower is the net promoter score. In the instance example as illustrated in the FIG. 3, the NPS is above 70 if 0 days are breached, that is, the order is delivered the same day as promised, and the NPS is below 30 when 4 days are breached from the promised date. This association will heavily impact the final vendor performance score calculations and hence, the selection of a vendor while assigning tasks for serving the logistic operations for the digital platform.

Now, referring again to FIG. 2, at step 208, the processing unit [102] determines a dynamic weight for one or more delivery performance factor of the set of delivery factors based on the association between the set of delivery performance factors data and the net promoter score. In this step, the processing unit [102] may use a modelling system to determine dynamic weights for the delivery performance factors, as explained above. The modelling system used for identifying the association between the set of delivery performance factors data and the net promoter score may be regarded as a pre-trained scoring sub-system. Further, the dynamic weight for each delivery performance factor is one of a positive weight or a negative weight. A ‘zero weight’, i.e., neither positive nor negative weight means that the delivery performance factor is not affecting the vendor performance score and thus, is not affecting the selection of the vendor on the digital platform. Further, the positive dynamic weight indicates a positive contribution in the vendor performance score and the negative dynamic weight indicates a negative contribution in the vendor performance score.

Further, at step 210, the processing unit [102] determines a vendor performance score based on the processed delivery performance factors and the dynamic weights associated with the processed delivery performance factors. In an implementation, the vendor scoring function is a simple weighted linear model.

After this, at step 212, the selection unit [106] selects a vendor based on the vendor performance score that is determined by the processing unit [102], for all the vendors that are associated with the digital platform to provide logistic services for the digital platform. In this, various parameters such as vendor's capacity, budget constraints and serviceability constraints are also considered while calculating the overall score for optimally selecting or allocating the vendor. Here, vendor's capacity refers to the maximum load shipments that can be delivered by a vendor in a given time, budget constraints include the costs or charges of the vendor to deliver a shipment, and serviceability constraints include whether a vendor delivers shipments in a geographical region or not. The process thus, ends at step 214.

It is evident from the above disclosure, that the solution provided by the disclosure is technically advanced as compared to the prior known solutions. The present disclosure is able to overcome the limitations of the existing systems or the known prior arts. The present disclosure overcomes the problems of vendor allocation done using the manual ratings that are unreliable. This is mainly done following in a systematic approach by scoring and selecting vendors based on the delivery performance. Thus, the present disclosure overcomes the major shortcomings of the existing methods, that is, sparsity of feedback data available, delays experienced in the data availability, and filtering noise in the available data. Implementing the present disclosure, a person skilled in the art would be able to optimally allocate vendors across the assignments in real-time and thereby optimize business metrics such as net promoter score, cost, order to delivery time, etc. while satisfying the constraints involved with the digital platform. Further, since the allocation of a business vendor takes into account several factors such as overall delivery time and first attempt conversion, which leads to increase in the speed to delivery of products by the digital platform and also further enhances customers' experience.

While considerable emphasis has been placed herein on the disclosed embodiments, it will be appreciated that many embodiments can be made and that many changes can be made to the embodiments without departing from the principles of the present disclosure. These and other changes in the embodiments of the present disclosure will be apparent to those skilled in the art, whereby it is to be understood that the foregoing descriptive matter to be implemented is illustrative and non-limiting.

We claim:

1. A method for selecting a vendor on a digital platform, the method comprising:
retrieving, by a transceiver unit [104], a data comprising a set of delivery performance factors data and a net promoter score for each historical order of one or more vendors on the digital platform;
identifying, by a processing unit [102], an association between the set of delivery performance factors data and the net promoter score;
determining, by the processing unit [102], a dynamic weight for one or more delivery performance factor of the set of delivery factors based on the association between the set of delivery performance factors data and the net promoter score;
determining, by the processing unit [102], a vendor performance score based on the one or more delivery performance factors and the dynamic weights associated with the one or more delivery performance factors; and
selecting, by a selection unit [106], the vendor based on the vendor performance score.

2. The method as claimed in claim 1, wherein the set of delivery performance factors data of the one or more vendors includes at least one of an order to delivery time, an extent of breach, a first attempt conversion, a shipping category, a service profile, a computed cluster, a payment type, a city tier, and a value variable.

3. The method as claimed in claim 1, wherein the determining the vendor performance score further comprises determining a normalized mean value of one or more delivery performance factors from the set of delivery performance factors for a predefined period of time.

4. The method as claimed in claim 1, wherein the dynamic weight for each delivery performance factor is one of a positive weight or a negative weight.

5. The method as claimed in claim 4, wherein the positive dynamic weight indicates a positive contribution in the vendor performance score and the negative dynamic weight indicates a negative contribution in the vendor performance score.

6. The method as claimed in claim 1 wherein identifying, by the processing unit [102], the association between the set of delivery performance factors data and the net promoter score is based on a pre-trained scoring sub-system, wherein the pre-trained sub-system is trained based on a historical order data retrieved by the transceiver unit [104].

7. The method as claimed in claim 1, wherein the selecting, by a selection unit [106], the vendor based on the vendor performance score, is further based on vendor's capacity, budget constraints and serviceability constraints.

8. A system for selecting a vendor on a digital platform, the system comprising:
a transceiver unit [104] configured to retrieve a data comprising a set of delivery performance factors data and a net promoter score for each historical order of one or more vendors on the digital platform;
a processing unit [102] configured to:
identify an association between the set of delivery performance factors data and the net promoter score;
determine a dynamic weight for one or more delivery performance factor of the set of delivery factors based on the association between the set of delivery performance factors data and the net promoter score;
determine a vendor performance score based on the one or more delivery performance factors and the dynamic weights associated with the one or more delivery performance factors; and
a selection unit [106] configured to select the vendor based on the vendor performance score.

9. The system as claimed in claim 8, wherein the set of delivery performance factors data of the one or more vendors includes at least one of an order to delivery time, an extent of breach, a first attempt conversion, a shipping category, a service profile, a computed cluster, a payment type, a city tier, and a value variable.

10. The system as claimed in claim 8, wherein the processing unit [102], for determining the vendor performance score, is further configured to determine a normalized mean value of one or more delivery performance factors from the set of delivery performance factors for a predefined period of time.

11. The system as claimed in claim 8, wherein the dynamic weight for each delivery performance factor is one of a positive weight or a negative weight.

12. The system as claimed in claim 11, wherein the positive dynamic weight indicates a positive contribution in the vendor performance score and the negative dynamic weight indicates a negative contribution in the vendor performance score.

13. The system as claimed in claim 8, wherein the processing unit [102] is configured to identify an association between the set of delivery performance factors data and the net promoter score based on a pre-trained scoring sub-system, wherein the pre-trained sub-system is trained based on a historical data retrieved by the transceiver unit [104].

14. The system as claimed in claim 8, wherein the selection unit [106] configured to select the vendor based on the vendor performance score is further configured to select the vendor based on vendor's capacity, budget constraints and serviceability constraints.
